(19) United States
(12) Patent Application Publication
(10) Pub. No.: US 2011/0221950 A1
(43) Pub. Date: Sep. 15, 2011

(54) CAMERA DEVICE, WAFER SCALE PACKAGE

(76) Inventors: Doeke Jolt Oostra, Valkenswaard (NL); Koen Gerard Demeyer, Genk (BE); Edwin Maria Wolterink, Valkenswaard (NL)

(21) Appl. No.: 13/046,225

(22) Filed: Mar. 11, 2011

Related U.S. Application Data
(60) Provisional application No. 61/313,252, filed on Mar. 12, 2010.

(51) Int. Cl. G02B 13/16

(52) U.S. Cl. 348/335; 348/E05.028

(57) ABSTRACT

A camera device comprising an image capturing element, one or more lens elements for projecting an object on the image capturing element, one or more spacer means for maintaining a predetermined distance between the lens and the image capturing element, and one or more lens substrates for carrying the lens, wherein the camera device further comprises an electrically variable focus polymer-stabilized liquid crystal lens.

### TECHNICAL FIELD

The invention relates to a camera device comprising an image capturing element, a lens element for projecting an object on the image capturing element, a spacer means for maintaining a predetermined distance between the lens and the image capturing element, and a lens substrate for carrying the lens.

### BACKGROUND OF INVENTION

Camera devices of this type are used in, for instance small portable devices such as mobile telephones, personal digital assistants (PDTs) and laptop computers

A camera device as mentioned in the opening paragraph is disclosed in the Japanese patent application published under number JP-2002/139662. The known camera device comprises an image pick-up element mounted on a substrate, and a lens support carrying one or more lenses. The lens support is integrally formed with the lens and is fastened to the image pick-up element whereby the lens support takes care of an accurate position in the direction of a main optical axis through the lenses on the image pick-up element. In a manufacturing process the individual image pick-up element, lens support, and lens are stacked and joined together. In order to obtain a high-quality image of an object on the image pick-up element, the dimensions of the lens support in the direction of the main optical axis should have a high accuracy. Furthermore positioning of these parts relative to each other should be accurate.

A disadvantage of the known camera device is that the manufacturing process each lens support has to be adjusted separately relative to the image pick-up element in each camera device, so there is little possibility to manufacture the known camera device in an efficient mass production process while maintaining a high positioning accuracy.

It is inter alia an object of the invention to provide a camera device of the type mentioned in the opening paragraph, having an increased capability for an efficient mass manufacturing process with a high positioning accuracy.

Another object of the invention is to provide a camera device of the type mentioned in the opening paragraph having an integrated variable focus function.

The present invention relates to a camera device as disclosed in the appending claims.

### SUMMARY OF THE INVENTION

In this arrangement the lens substrate including the lens element and the spacer means comprising the adhesive layer, can be positioned and aligned along the main optical axis through the lens element and the image capturing element, after which a predetermined distance is set between the lens element and the image capturing device. After hardening the adhesive layer this predetermined distance is maintained by the spacer means. This arrangement provides increased capabilities for mass manufacturing wherein a plurality of image capturing elements, lens elements and spacer means can be manufactured on a base substrate comprising the imaging elements and a lens substrate respectively, whereby the base substrate and the lens substrate are stacked and joined with a high accuracy and the individual camera devices are separated from the stack. The hardening of the adhesive layer can be performed in case of an ultra-violet curable adhesive by UV radiation or in case of a thermo-hardening adhesive by heating the adhesive layer.

According to the present invention the electrically variable focus polymer-stabilized liquid crystal lens can be mounted in between two lens plates, on top of a lens system, on top of an image sensor. In a preferred embodiment the electrically variable focus polymer-stabilized liquid crystal lens has lenses on top and bottom. It is also possible to have two or more electrically variable focus polymer-stabilized liquid crystal lens present in one camera device.

An example of such a liquid crystal lens has been disclosed in U.S. Pat. No. 7,218,375 and in EP 1 843 198.

In variable focal length lenses based on flat layers of nematic liquid crystals (NLC) a non-homogeneous electric field is used to induce a suitable configuration of the NLC director (that is, the direction of the preferred molecular orientation) in a cell so as to create a lens-like distribution of the refractive index. Non-homogeneous electric fields can be generated by means of suitable electrode structures provided on one or both cell substrates.

A small amount (e.g. up to 3%) of a reactive monomer can be added to the NLC. The reactive monomer is substantially uniformly polymerized in situ by uniform UV irradiation during application of the non-homogenous electric field. Polymerization of the monomer in this manner leads to the formation of a spatially uniform polymer network structure or matrix, which reduces the ease with which the NLC director can be reoriented. Accordingly, polymerization of the monomer while the NLC while under the influence of the non-uniform electric field reduces the tendency of the NLC director to re-orient back to its relaxed state when the electric field is removed, thereby producing a “permanent” lens within the NLC.

According to a preferred embodiment a variable focal length is generated by inducing the formation of a spatially non-homogenous polymer network within an NLC/monomer mixture contained within a cell, in the presence of a uniform electric field. The NLC/monomer mixture may be composed of any suitable nematic liquid crystal and a small amount (e.g. about 3% by weight) of photopolymerizable monomer. However, the present variable focal length lenses are not restricted to a combination of NLC and a monomer, but in certain embodiments there is only NLC present.

The lens or so called LCD lens can conveniently be defined by a pair of substantially parallel transparent substrates separated by a gap that is filled with the NLC or so called LCD matrix. Each substrate (which may, for example, be made of glass) includes a transparent electrode (e.g. of Tin Oxide; Indium Tin Oxide (ITO) etc.) preferably coated with a surfactant (e.g. rubbed PMMA) to define a uniform rest-state orientation of the NLC director. Electrodes are connected to a voltage source, which enables the generation of a substantially uniform electric field through the NLC or LCD matrix within the cell. Thin films of indium tin oxide can be deposited on surfaces by electron beam evaporation, physical vapor deposition, or a range of sputter deposition techniques.

The camera device has been disclosed by the present applicant in WO 2004/027880 and WO 2009/048320. These documents are incorporated here by reference. The replication process for making polymer lenses is known per se from U.S. Pat. Nos. 4,756,972 and 4,890,905, which disclose the possibility of manufacturing a high-quality optical component by means of a replication process. Such a replication process is considered to be a quick and inexpensive manner of manufacturing optical components in large numbers. In the replication process, a mould having a precisely defined surface, for example an aspherical surface, is used, and a small amount of a radiation curable resin, for example a UV curable resin, is applied to the mould surface. Subsequently, the resin is spread over the mould surface, so that the cavities in the mould are filled with the resin, after which the whole is irradiated so as to cure the resin and the thus cured product is removed from the mould. The cured product is a negative of the mould surface. An advantage of the replication process is that lenses having a complex refractive surface, such as an aspherical surface, can be manufactured in a simple manner without having to subject the lens body to intricate grinding and polishing processes.

The replica layer used in the present optical system is preferably composed of a UV curable polymer, selected from the group of polycarbonates, polystyrenes, poly(meth)acrylates, polyurethanes, polyamids, polyimids, polyethers, polyepoxides and polyesters. Suitable replication technologies are disclosed in U.S. Pat. Nos. 6,773,638 and 4,890,905, which may be considered to be fully incorporated herein

From International application WO 03/069740 in the name of the present inventor there is also known a replication process by which an optical element is formed.

The present invention thus provides an optical integration in which the electrically variable focus polymer stabilized liquid crystal lens forms a part of the total optical design. The wafer optics design according to the present invention provides an optical performance and image quality, e.g. MTF, within a certain operating window. Important parameters are, inter alia, focal range and field of view. The integration of the liquid crystal lens enables the improvement of this range around a nominal value. In addition, there is a mechanical integration as well, because all sub components, i.e. lens plates, spacer means, sensor plates and LCD module, can be produced on a wafer scale level. This will result in a compact module, especially a lower Z height, and reduced costs.

### DETAILED DESCRIPTION OF THE DRAWINGS

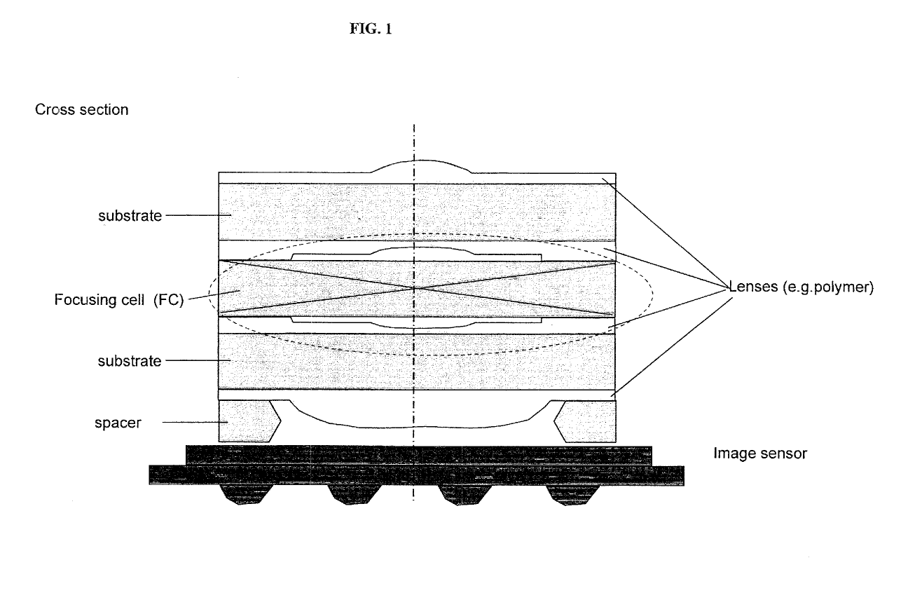

FIGS. 1-11 are cross-sectional views of the camera device according to the present invention.

FIG. 1 schematically shows a first embodiment of a camera device. The camera device comprises an image capturing element, i.e. an image sensor (CMOS), a spacer, a lens, a substrate, a lens, an electrically variable focus polymer-stabilized liquid crystal lens (focusing cell (FC)), a lens, a substrate and a lens. In this embodiment the FC is mounted in between two lens plates, i.e. the two substrates.

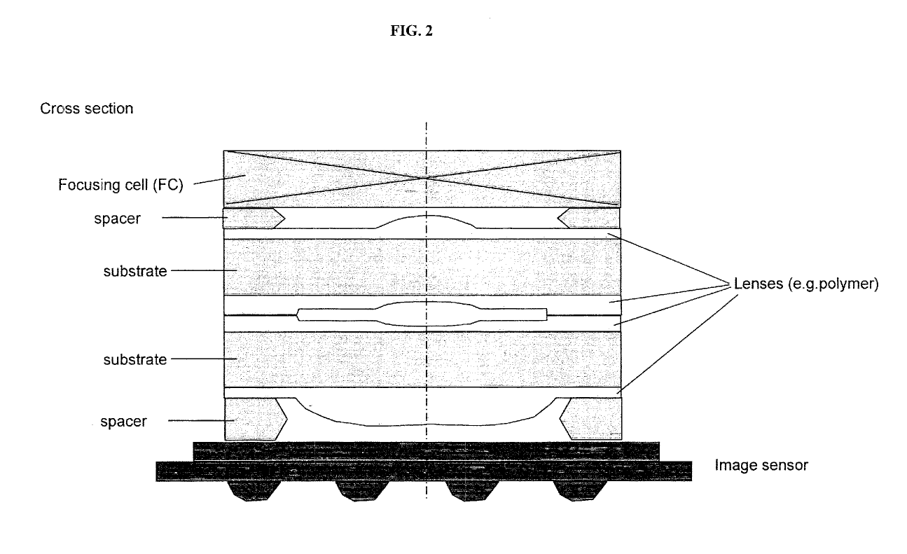

FIG. 2 schematically shows a second embodiment of a camera device. The camera device comprises an image sensor, a spacer, a lens, a substrate, a lens, a lens, a substrate, a lens, a spacer and the electrically variable focus polymer-stabilized liquid crystal lens (focusing cell (FC)). In this construction the FC is mounted on top of a lens system.

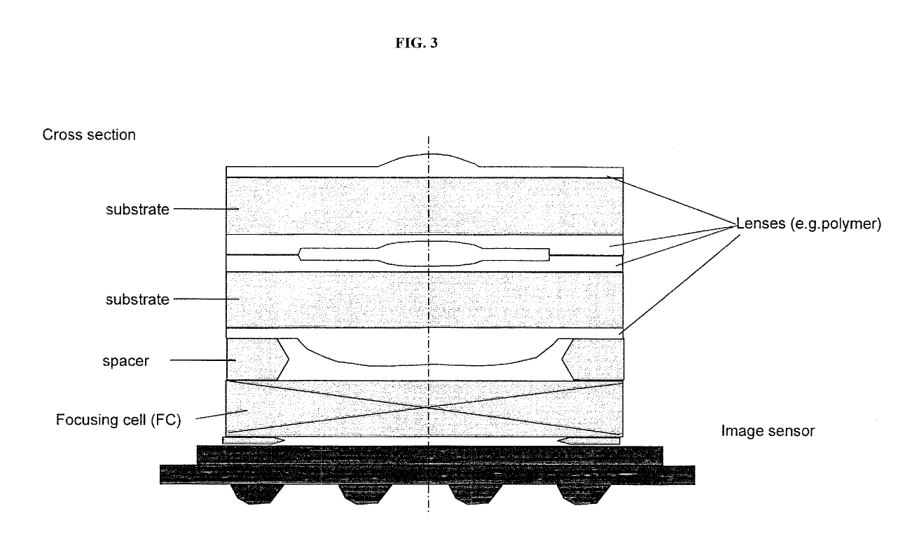

FIG. 3 schematically shows a third embodiment of a camera device. The camera device comprises an image sensor, a spacer, an electrically variable focus polymer-stabilized liquid crystal lens (focusing cell (FC)), a spacer, a lens, a substrate, a lens, a lens, a substrate, and a lens. According to this construction the FC is mounted on top of the image sensor.

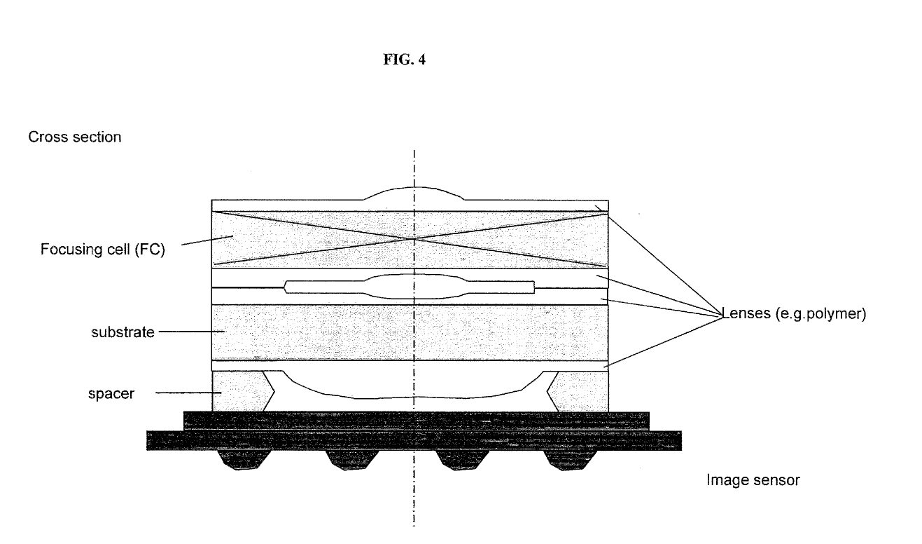

FIG. 4 schematically shows a fourth embodiment of a camera device. The camera device comprises an image sensor, a spacer, a lens, a substrate, a lens, a lens, an electrically variable focus polymer-stabilized liquid crystal lens (focusing cell (FC)), and a lens. This construction shows that the FC has lenses on top and bottom.

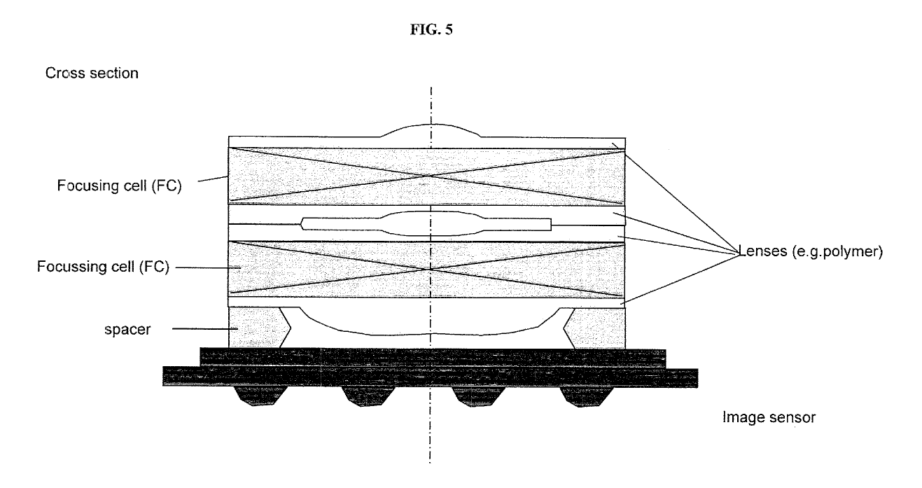

FIG. 5 schematically shows a fifth embodiment of a camera device. The camera device comprises an image capturing element, a spacer, a lens, a first electrically variable focus polymer-stabilized liquid crystal lens (focusing cell (FC)), a lens, a lens, a second electrically variable focus-polymer-stabilized liquid crystal lens (FC), and a lens. This construction discloses the incorporation of two focusing cells within one camera device. Besides focusing, also zooming becomes possible with such a construction.

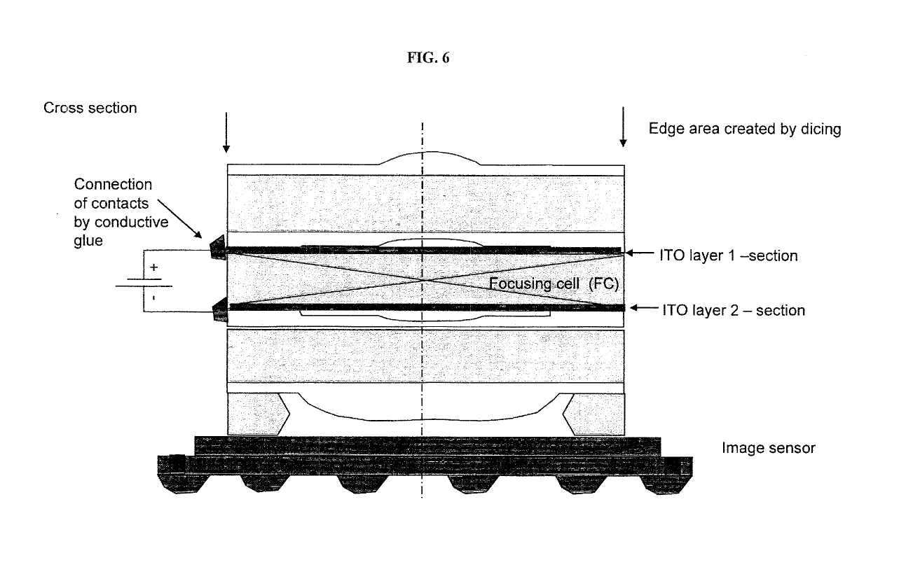

FIG. 6 schematically shows a first embodiment of creating electrical contact. The camera device comprises an electrically variable focus polymer-stabilized liquid crystal lens (focusing cell (FC)), wherein ITO layers are on top and bottom of said FC. The connection of contacts takes place by the application of a conductive glue. The edge area is created by dicing, wherein the ITO layer 1—section and the ITO layer 2—section are created at dicing of the stack. Subsequently, the conductive glue is applied on area with ITO layers and the connection of contacts takes place by the conductive glue.

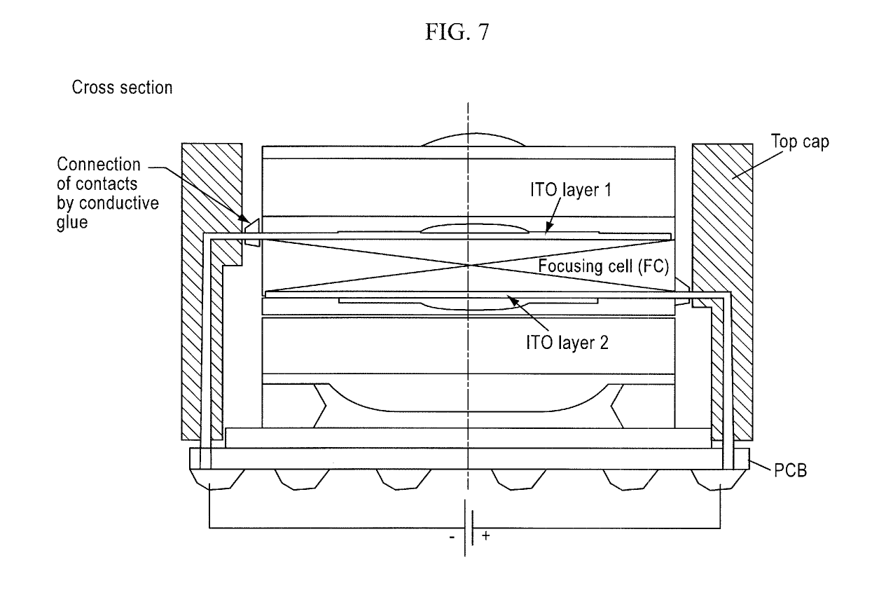

FIG. 7 schematically shows a connection of contacts by conductive glue. The contacting of ITO layers is achieved by a Cap with conductive elements, such a wires. The contact between the wires and the ITO is provided by conductive glue. At the bottom, the wires make contact with printed circuit board (PCB).

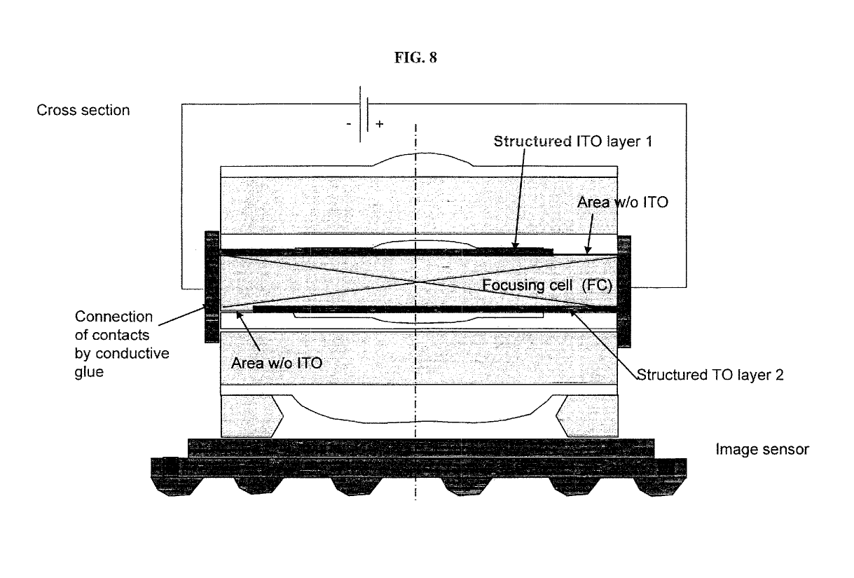

FIG. 8 schematically shows a second embodiment of creating electrical contacts. The electrically variable focus polymer-stabilized liquid crystal lens (focusing cell (FC)) needs contacting by the ITO layers that are on top and bottom of the FC. The ITO layers are structured in such a way that areas are created without ITO, i.e. so-called non-conductive areas. Subsequently the stack is diced resulting in the creation of section of ITO layers. After dicing the stack the application of a conductive glue takes place and connection of contacts by conductive glue. In this embodiment, the glue may be dispensed over one large part of the side areas.

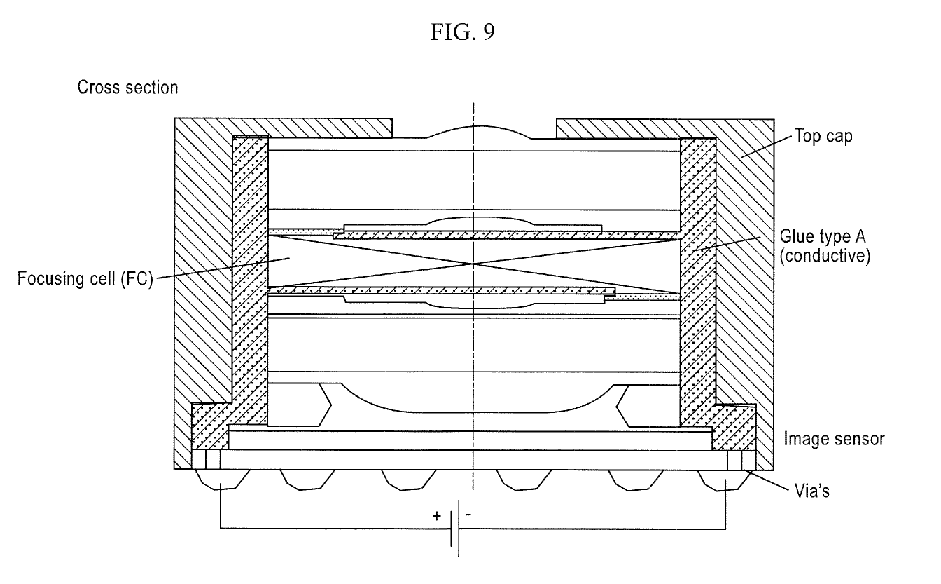

FIG. 9 schematically shows another embodiment of creating electrical contacts. The electrically variable focus polymer-stabilized liquid crystal lens (focusing cell (FC)) is mounted in between two lens plates. The FC has structured ITO layers on bottom and top. By the application of two dots of glue that do not contact (shortcut) to each other, contacting is achieved from the ITO layers to the via's and the contacting balls.

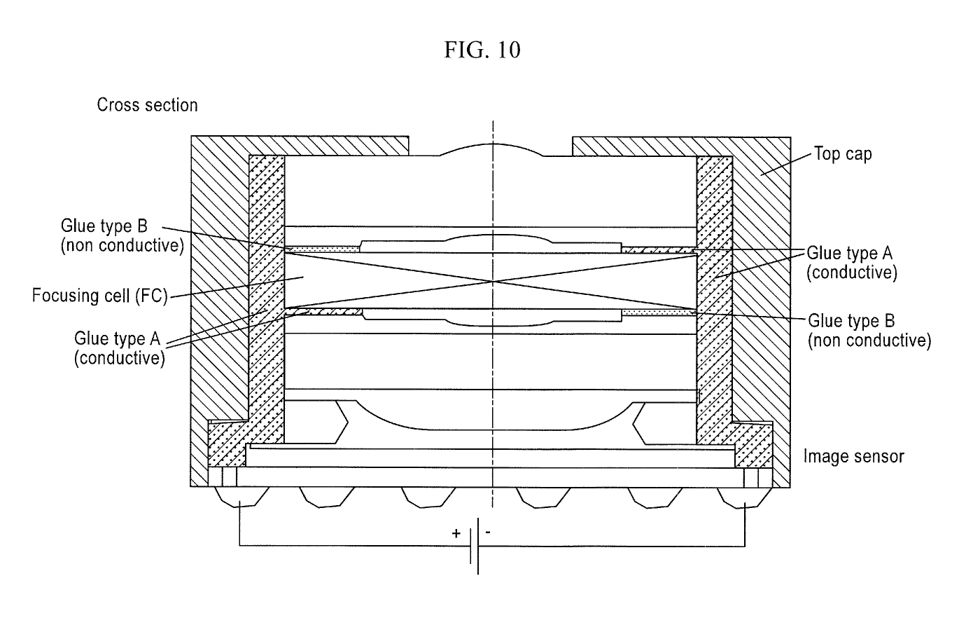

FIG. 10 schematically shows another embodiment of creating electrical contacts. In this construction the electrically variable focus polymer-stabilized liquid crystal lens (focusing cell (FC)) is mounted in between two lens plates, wherein the FC has ITO layers on bottom and top. The contact is achieved by a conductive and non-conductive glue.

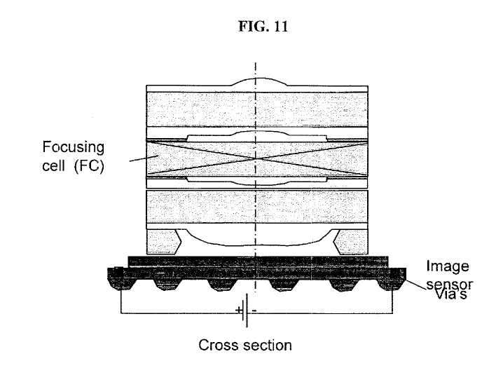

FIG. 11 schematically shows another embodiment of creating electrical contacts. According to this embodiment the electrically variable focus polymer-stabilized liquid crystal lens (focusing cell (FC)) is mounted in between two lens plates. The FC has structured ITO layers on bottom and top. By applying via's in the lens unit, and by applying a conductive glue, contacting is achieved.

The dimensions of the technical features mentioned in the above-discussed embodiments are: ILS (mm): 1-6, typical 2-3, glass substrate (mm): 0.1-2, typical 0.3-1.1, lens SAG (pm): 10-1000, typical 60-400, replica buffer layer (μm): 10-200, typical 30-100. The ITO, IR and coating are standardized, i.e. very thin nanometers to maximally 5 pm for a very thick IR coating. The thickness of CMOS sensors and PCB are standardized.

The adhesive layer comprises an ultra-violet curing resin or a thermo-hardening resin. The spacer comprises a whole coaxially positioned relative to a main optical axis of the lens element. The separate parts of the camera device are connected by an adhesive layer, wherein the thickness of the adhesive layer is between 2 μm and 100 μm, preferably between 5 μm and 100 μm. The forming of a replica layer on glass takes place via a silane coupling agent, without any adhesive.

In a specific embodiment it is also possible to connect the separate parts through soldering.

In a specific embodiment the lens element is of a replication type. In a specific embodiment the lens substrate is provided with an infra-red reflecting layer. In another specific embodiment the lens substrate is provided with an anti-reflection layer. In another embodiment, the spacer substrate is provided with an anti-reflection layer. The predetermined distances along the optical axis through the individual lens elements, the associated image capturing elements and the focusing cell between the different substrates can be accurately adjusted after stacking of the substrate and maintained by hardening of the adhesive layer between the different substrates. After completing the stack, the individual camera devices can be separated from the stack. The efficient mass production of the camera device takes place by providing a wafer skilled package comprising a base substrate having a plurality of image capturing elements, comprising a lens substrate having a plurality of lens elements associated with respective image capturing elements, spacer means for maintaining the pre-determined distance and the focusing cell as discussed above. The position of the lens substrate relative to the other substrate is fixated preferably by means of a adhesive layer. In such a wafer skilled package the lenses are already aligned. The method as such has been disclosed in WO 2004/027880 in the name of the present applicant and is incoporated by reference as a whole.

What is claimed is:

1. A camera device comprising an image capturing element, one or more lens elements for projecting an object on the image capturing element, one or more spacer means for maintaining a predetermined distance between the lens and the image capturing element, and one or more lens substrates for carrying the lens, wherein the camera device further comprises an electrically variable focus polymer-stabilized liquid crystal lens.

2. A camera device in accordance with claim 1, wherein the electrically variable focus polymer-stabilized liquid crystal lens is mounted in between two lens substrates.

3. A camera device in accordance with claim 1, wherein the electrically variable focus polymer-stabilized liquid crystal lens is mounted on top of a lens substrate.

4. A camera device in accordance with claim 1, wherein the electrically variable focus polymer-stabilized liquid crystal lens is mounted directly on the image capturing element.

5. A camera device in accordance with claim 1, wherein the electrically variable focus polymer-stabilized liquid crystal lens possesses lens elements on both surfaces.

6. A camera device in accordance with claim 1, wherein two electrically variable focus polymer-stabilized liquid crystal lenses are present in the camera device, separated by one or more lenses.

7. A camera device in accordance with claim 1, wherein the electrically variable focus polymer-stabilized liquid crystal lens is provided with ITO layers on both sides for creating electrical contact.

8. A camera device in accordance with claim 7, wherein the connection of contacts is obtained by a conductive glue.

9. A camera device in accordance with claim 7, wherein the electrically variable focus polymer-stabilized liquid crystal lens is provided by ITO layers on both sides, wherein said ITO layers are structured in such a way that a part of each side of the liquid crystal lens lacks the ITO layer thereby creating areas which are non-conductive, wherein the electrical contact between the ITO layers is established by a conductive glue.

10. A camera device in accordance with claim 1, wherein the electrically variable focus polymer-stabilized liquid crystal lens is provided with ITO layers on both sides, wherein an electrical contact between these two ITO layers is obtained by a conductive glue and conductive element.

11. A camera device in accordance with claim 10, further comprising a printed circuit board, wherein the conductive element is a wire contacting with the printed circuit board.

12. A camera device in accordance with claim 1, wherein the electrically variable focus polymer-stabilized liquid crystal lens is provided with ITO layers on both sides thereof, wherein an electrical contact is established by providing non-conductive and conductive glues on both sides of the liquid crystal lens.
